(19) United States
(12) Patent Application Publication
(10) Pub. No.: US 2025/0011625 A1
(43) Pub. Date: Jan. 9, 2025

(54) SOLVENT COMPOSITION FOR WELDING OPTICAL MODULE AND CAMERA MODULE USING THE SAME

(71) Applicant: SAMSUNG ELECTRO-MECHANICS CO., LTD., Suwon-si (KR)

(72) Inventors: Seong Chan PARK, Suwon-si (KR); Sang Hyeon HONG, Suwon-si (KR); Sang Hyun KWON, Suwon-si (KR)

(73) Assignee: SAMSUNG ELECTRO-MECHANICS CO., LTD., Suwon-si (KR)

(21) Appl. No.: 18/630,199

(22) Filed: Apr. 9, 2024

(30) Foreign Application Priority Data
Jul. 3, 2023 (KR) 10-2023-0085455

(51) Int. Cl. C09J 4/00; G03B 17/12

(52) U.S. Cl. CPC C09J 4/00; G03B 17/12; G03B 2217/002

(57) ABSTRACT

A solvent composition for welding an optical module includes a first solvent and a second solvent. The first solvent includes at least one solvent selected from a first group having a swelling ratio of 60% or more, and the second solvent includes at least one solvent selected from a second group having a swelling ratio of less than 60%.

### CROSS-REFERENCE TO RELATED APPLICATIONS

This application claims the benefit under 35 USC 119 (a) of Korean Patent Application No. 10-2023-0085455, filed on Jul. 3, 2023, in the Korean Intellectual Property Office, the entire disclosure of which is incorporated herein by reference for all purposes.

### BACKGROUND

### 1. Field

The following description relates to a solvent composition for welding an optical module and a camera module using the composition.

### 2. Description of the Background

A camera module may include a lens. For example, a high-resolution camera module may include four or more lenses that are disposed in a lens barrel.

The camera module may include a component to prevent the lens disposed on the lens barrel from being separated. For example, the camera module may include a press-fit ring or adhesive for fixing the lens to the lens barrel.

However, a conventional adhesive for an optical module may be a UV curing adhesive, a heat curing adhesive, or a UV heat curing adhesive that may be significantly expensive per unit gram (g). In addition, curing and shrinkage of the adhesive may cause a change in the MTF of the lens or non-curing of a core, which may increase the defect rate of the camera module.

Typical bonding force (or binding force) between the press-fit ring and the lens barrel when fixing the lens through a press-fit ring is inadequate.

The above information is presented as background information only to assist with an understanding of the present disclosure. No determination has been made, and no assertion is made, as to whether any of the above might be applicable as prior art with regard to the disclosure.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one general aspect, a solvent composition for welding an optical module includes a first solvent and a second solvent. The first solvent includes at least one solvent selected from a first group having a swelling ratio of 60% or more, and the second solvent includes at least one solvent selected from a second group having a swelling ratio of less than 60%.

The first solvent may be at least one of methylene chloride (MC) and tetrahydrofuran (THF), and the second solvent may be at least one of ethyl acetate (EA), methyl ethyl ketone (MEK), and acetone (AC).

The first solvent may be THF and the second solvent may be MEK.

The solvent composition may include 70 to 95% by volume of MEK and 5 to 30% by volume of THF.

A camera module includes a lens barrel accommodating a plurality of lenses, and a press-fit ring disposed in the lens barrel to support the plurality of lenses. The solvent composition may be used to couple the press-fit ring to the lens barrel.

In another general aspect, a camera module includes a plurality of lenses, a lens barrel in which an accommodation space for accommodating the plurality of lenses is formed, and a press-fit ring bonded to the lens barrel by a solvent composition including a first solvent selected from a first group having a swelling ratio of 60% or more, and a second solvent selected from a second group having a swelling ratio of less than 60%.

The first solvent may be at least one of methylene chloride (MC) and tetrahydrofuran (THF), and the second solvent may be at least one of ethyl acetate (EA), methyl ethyl ketone (MEK), and acetone (AC).

The first solvent may be THF and the second solvent may be MEK.

The solvent composition may include 70 to 95% by volume of MEK and 5 to 30% by volume of THF.

The plurality of lenses may include a first lens group including a frontmost lens disposed most adjacently to an object, and a second lens group including a rearmost lens disposed most adjacently to an image plane. The lens barrel may include a first accommodation space for accommodating the first lens group and a second accommodation space for accommodating the second lens group.

A gap maintenance member may be disposed between the first lens group and the second lens group.

In another general aspect, a solvent composition for welding an optical module includes a first solvent consisting of at least one solvent selected from a first group having a swelling ratio of 60% or more, and a second solvent consisting of at least one solvent selected from a second group having a swelling ratio of less than 60%.

Other features and aspects will be apparent from the following detailed description, the drawings, and the claims.

### BRIEF DESCRIPTION OF DRAWINGS

FIG. 1 is a cross-sectional view of a camera module according to an embodiment.

FIG. 2 is an enlarged view of portion A illustrated in FIG. 1.

FIG. 3 is a bottom view of the camera module illustrated in FIG. 1.

FIG. 4 is a graph illustrating a swelling ratio and adhesion of flat specimens according to solvent.

FIG. 5 is a graph illustrating a change in adhesion according to an amount of THF in a mixed solvent of THF and MEK.

FIG. 6 is a graph comparing the removal force of a conventional solvent composition using an acetone solvent and a solvent composition using a mixed solvent of THF and MEK.

FIG. 7 is a graph comparing whether a solvent composition using a conventional acetone solvent and a solvent composition using a mixed solvent of THF and MEK remains.

Throughout the drawings and the detailed description, unless otherwise described, the same reference numerals refer to the same elements. The drawings may not be to scale, and the relative size, proportions, and depiction of elements in the drawings may be exaggerated for clarity, illustration, and convenience.

### DETAILED DESCRIPTION

Hereinafter, while examples of the present disclosure will be described in detail with reference to the accompanying drawings, it is noted that examples are not limited to the same.

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of this disclosure. For example, the sequences of operations described herein are merely examples, and are not limited to those set forth herein, but may be changed as will be apparent after an understanding of this disclosure, with the exception of operations necessarily occurring in a certain order. Also, descriptions of features that are known in the art may be omitted for increased clarity and conciseness.

The features described herein may be embodied in different forms, and are not to be construed as being limited to the examples described herein. Rather, the examples described herein have been provided merely to illustrate some of the many possible ways of implementing the methods, apparatuses, and/or systems described herein that will be apparent after an understanding of this disclosure.

Throughout the specification, when an element, such as a layer, region, or substrate is described as being “on,” “connected to,” or “coupled to” another element, it may be directly “on,” “connected to,” or “coupled to” the other element, or there may be one or more other elements intervening therebetween. In contrast, when an element is described as being “directly on,” “directly connected to,” or “directly coupled to” another element, there can be no other elements intervening therebetween.

As used herein, the term “and/or” includes any one and any combination of any two or more of the associated listed items; likewise, “at least one of” includes any one and any combination of any two or more of the associated listed items.

Although terms such as “first,” “second,” and “third” may be used herein to describe various members, components, regions, layers, or sections, these members, components, regions, layers, or sections are not to be limited by these terms. Rather, these terms are only used to distinguish one member, component, region, layer, or section from another member, component, region, layer, or section. Thus, a first member, component, region, layer, or section referred to in examples described herein may also be referred to as a second member, component, region, layer, or section without departing from the teachings of the examples.

Spatially relative terms, such as “above,” “upper,” “below,” “lower,” and the like, may be used herein for ease of description to describe one element's relationship to another element as shown in the figures. Such spatially relative terms are intended to encompass different orientations of the device in use or operation in addition to the orientation depicted in the figures. For example, if the device in the figures is turned over, an element described as being “above,” or “upper” relative to another element would then be “below,” or “lower” relative to the other element. Thus, the term “above” encompasses both the above and below orientations depending on the spatial orientation of the device. The device may also be oriented in other ways (rotated 90 degrees or at other orientations), and the spatially relative terms used herein are to be interpreted accordingly.

The terminology used herein is for describing various examples only, and is not to be used to limit the disclosure. The articles “a,” “an,” and “the” are intended to include the plural forms as well, unless the context clearly indicates otherwise. The terms “comprises,” “includes,” and “has” specify the presence of stated features, numbers, operations, members, elements, and/or combinations thereof, but do not preclude the presence or addition of one or more other features, numbers, operations, members, elements, and/or combinations thereof.

Due to manufacturing techniques and/or tolerances, variations of the shapes shown in the drawings may occur. Thus, the examples described herein are not limited to the specific shapes shown in the drawings, but include changes in shape that occur during manufacturing.

Herein, it is noted that use of the term “may” with respect to an example, for example, as to what an example may include or implement, means that at least one example exists in which such a feature is included or implemented while all examples are not limited thereto.

The features of the examples described herein may be combined in various ways as will be apparent after an understanding of this disclosure. Further, although the examples described herein have a variety of configurations, other configurations are possible as will be apparent after an understanding of this disclosure.

The camera module described herein may be installed in portable electronic products. For example, the camera module may be installed in a portable phone, laptop, and the like. However, the scope of use of the camera module, according to the present embodiment, is not limited to the electronic devices described above. For example, the camera module may be installed in all electronic devices requiring screen imaging and video recording, such as motion detection, image capture, facial recognition, iris recognition, virtual reality implementation, augmented reality implementation, and the like.

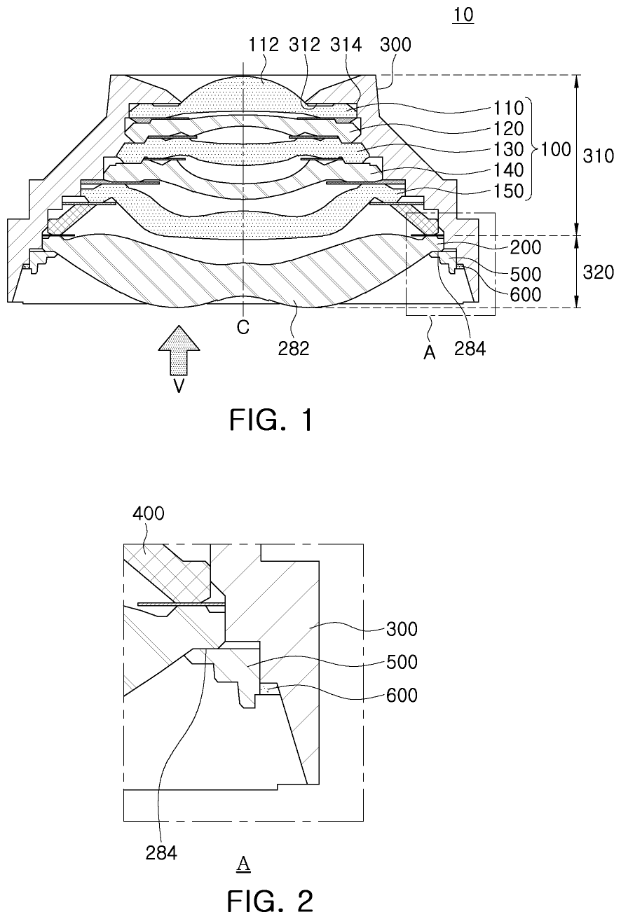

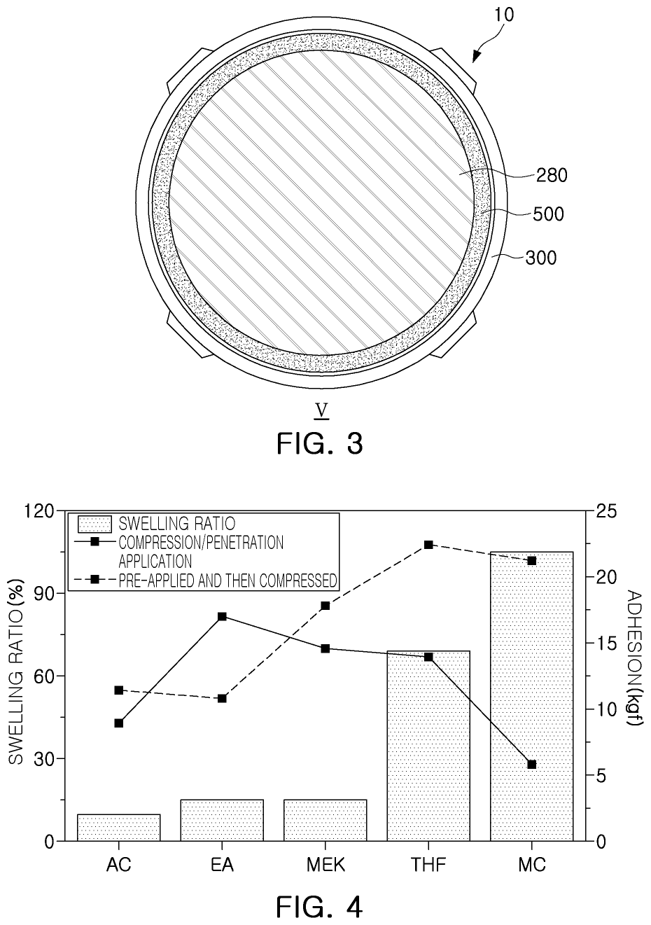

According to an embodiment, a camera module will be described with reference to FIGS. 1 to 3.

A camera module 10 includes a plurality of lenses, a lens barrel 300 in which an accommodation space for accommodating the plurality of lenses is formed, and a press-fit ring 500.

The lens may be divided into a first lens group 100 and a second lens group 200. However, the configuration of the camera module 10 is not limited to the configurations described above.

For example, the camera module 10 may further include a filter (not shown), an image sensor (not shown), and the like. In addition, the camera module 10 may further include a driving means for driving the lens barrel 300 in an optical axis or a direction intersecting the optical axis.

The first lens group 100 may include one or more lenses. For example, the first lens group 100 may include a frontmost lens 110 disposed most adjacently to an object.

The frontmost lens 110 may include an optical portion 112 and a flange portion 114. The optical portion 112 is configured to exhibit optical performance, and the flange portion 114 is configured to enable positional alignment of the lens.

For example, the optical portion 112 may be configured to have positive or negative refractive power, and the flange portion 114 may be configured to contact an adjacent lens or lens barrel 300.

The optical portion 112 may be exposed externally of the lens barrel 300. For example, the optical portion 112 may be partially or fully exposed through an opening of the lens barrel 300, as shown in FIG. 1. In contrast, the flange portion 114 may be configured not to be exposed through the opening of the lens barrel 300.

The frontmost lens 110 may be disposed in an innermost portion of the lens barrel 300. The frontmost lens 110 may contact a plurality of different inner surfaces of a first accommodation space 310, to be described later.

For example, an object-side surface of the flange portion 114 may be in contact with an upper surface 312 of the first accommodation space 310, and an outer peripheral surface of the flange portion 114 may be in contact with an inner surface 314 of the first accommodation space 310.

Accordingly, the frontmost lens 110 may be aligned to match an optical axis C of the lens barrel 300 by being installed in the lens barrel 300.

The first lens group 100 may include a plurality of lenses. For example, the first lens group 100 may further include one or more lenses in addition to the frontmost lens 110.

For reference, the first lens group 100, according to the present embodiment, may further include four lenses 120, 130, 140, and 150, in addition to the frontmost lens 110. However, the number of lenses forming the first lens group 100 is not limited to five. For example, depending on the optical performance of the camera module 10, the first lens group 100 may be comprised of less than 5 lenses or 6 or more lenses.

The lenses 110, 120, 130, 140, and 150 of the first lens group 100 may generally have larger diameters from an object side toward an image plane. For example, the second lens 120 may have a larger diameter than the first lens 110 (frontmost lens), and the third lens 130 may have a larger diameter than the second lens 120.

However, the positions of the lenses 110, 120, 130, 140, and 150 and the sizes of the lenses are not necessarily proportional. For example, the fourth lens 140 and the third lens 130 may be formed to be substantially the same size. Among the lenses of the first lens group 100, a lens disposed most adjacently to the second lens group 200 may generally have the largest diameter. For example, in the present embodiment, the fifth lens 150 may have a larger diameter than the first to fourth lenses 110 to 140.

The second lens group 200 may include one or more lenses. For example, the second lens group 200 may include a rearmost lens 280 disposed most adjacently to an image plane. The rearmost lens 280 may include an optical portion 282 and a flange portion 284.

The optical portion 282 is configured to exhibit optical performance, and the flange portion 284 is configured to enable positional alignment of the lens. For example, the optical portion 282 may be configured to have positive or negative refractive power, and the flange portion 284 may be configured to contact the lens barrel 300. An outer peripheral surface of the flange portion 284 may be configured to be generally parallel to an optical axis C.

The lens barrel 300 is configured to accommodate the first lens group 100 and the second lens group 200 therein. For example, a first accommodation space 310 and a second accommodation space 320 may be formed inside the lens barrel 300.

The first accommodation space 310 is configured to accommodate the first lens group 100. For example, the first accommodation space 310 may be formed to have a considerable size to accommodate the lenses 110, 120, 130, 140, and 150 of the first lens group 100.

A step may be formed in the first accommodation space 310. For example, a plurality of steps may be formed in the first accommodation space 310 to specify accommodation positions of the first to fifth lenses 110 to 150. These steps may be formed to have different sizes. For example, each of the steps may be formed to substantially match the size of the first to fifth lenses 110 to 150.

The second accommodation space 320 is configured to accommodate a second lens group 200. For example, the second accommodation space 320 may be formed to accommodate a rearmost lens 200 of the second lens group 200.

The camera module 10 may further include a gap maintenance member 400. The gap maintenance member 400 may be disposed between the first lens group 100 and the second lens group 200.

For example, the gap maintenance member 400 may be disposed between the fifth lens 150 and the rearmost lens 200. In this case, the gap maintenance member 400 may maintain a distance in an optical axis direction between the fifth lens 150 and the rearmost lens 200 to be constant.

In addition, the gap maintenance member 400 may serve to increase the bonding force between the rearmost lens 200 and the lens barrel 300 by acting on or transmitting a force in a direction of the image plane to the rearmost lens 200.

The camera module 10 configured as above may improve the bonding force between the lens barrel 300 and the rearmost lens 200 so that the phenomenon of the rearmost lens 200 and other lenses being separated from the lens barrel 300 due to external impacts may be significantly reduced.

A press-fit ring 500 is installed to fix the rearmost lens 200 of the second lens group 200 and the lens barrel 300.

The press-fit ring 500 may be configured in the form of an annular ring, may be installed in the lens barrel 300 to press-fit and fix the lens and support a lower edge portion of the lens, and may have a plurality of support portions formed to extend directly below an inner peripheral surface thereof.

The press-fit ring 500 and the lens barrel 300 are bonded to each other using solvent welding technology by applying a solvent composition 600 therebetween.

According to an embodiment of the present disclosure, the solvent composition is used to assemble a lens and a lens barrel in the camera module using a simple and economical method of bonding a thermoplastic resin known as solvent welding technology. In the present disclosure, more specifically, an optimized solvent composition is applied to a bonded area between the press-fit ring and the lens barrel, softened, and then pressed together to bond the press-fit ring and the lens barrel.

Such solvent welding technology has the advantage of bonding quickly through solvent evaporation simply by heating to an appropriate temperature instead of using separate curing equipment such as UV.

Conventionally, acetone (AC) or ethyl acetate (EA) has been used as a welding solvent. When acetone and ethyl acetate are used on a product with a small diameter, it is difficult to secure an adhesive area, and there is a concern that the removal force may be insufficient.

Accordingly, the present disclosure discloses a solvent composition with superior adhesion compared to existing AC and EA so that applicability may be expanded to various models, such as a model with a small diameter or the like.

Taking this into account, in the present disclosure, first, the basic physical properties of a barrel and a press ring resin (e.g., PC series) and candidate organic solvents are evaluated to classify various solvents, and adhesion is evaluated on specimens and products to select a solvent composition for welding an optical module.

Solvent welding technology ultimately improves bonding force through increased fluidity of a polymer chain by a solvent and diffusion and rearrangement of the polymer at an interface. For this reason, selecting an appropriate solvent with high reactivity with a target polymer is a top priority.

To this end, the basic physical properties of the solvent are determined by measuring the swelling ratio of the polymer to the solvent and evaluating the spreadability of the solvent on the surface of the polymer.

It is generally known that the larger an adhesion area and dissolution power, the better the adhesion. To this end, in an embodiment, two or more solvents are mixed instead of a single solvent to secure physical properties, and adhesion evaluation for each composition is performed to select an excellent solvent.

Taking this into account, the solvent composition of an embodiment is composed of two types of solvents. In this case, the first solvent having a high swelling ratio increases swelling solubility of the resin, causing more surface dissolution of the resin, and as a result, when the solvent is removed, miscibility between the two materials increases, thereby improving adhesion.

The first solvent includes at least one solvent selected from a first group having a high swelling ratio, and the solvent of the first group has a swelling ratio of 60% or more.

In addition, the solvent of the first group may be at least one of methylene chloride (MC) and tetrahydrofuran (THF).

The second solvent includes at least one solvent selected from a second group with a low swelling ratio, and the solvent of the second group has a swelling ratio of less than 60%.

In addition, the solvent of the second group may be at least one of ethyl acetate (EA), methyl ethyl ketone (MEK), and acetone (AC).

In the five solvents AC, EA, MEK, MC, and THF, for swelling characteristics, MC>THF>MEK≈EA>AC, and for spreadability, AC>EA≈MEK>THF≈MC.

The solvent composition of this embodiment may include MEK and THF, and may include 70 to 95% by volume of MEK and 5 to 30% by volume of THF.

In this case, when a content of MEK is less than 70% by volume, a surface of a resin to be bonded may whiten, causing a problem with the appearance of the product, and when the content of MEK exceeds 95% by volume, there is little effect in improving adhesion.

A conventional lens and lens barrel are bonded using a heat-cured adhesive using UV.

Specifically, after applying the heat-curing adhesive, the heat-curing adhesive is pre-cured with UV at 3000 mj or less, and then heat-cured at 90° C. for 30 minutes to cure the adhesive. In this case, an adhesive force of 15 kgf or less can be provided.

Acetone is conventionally used as a solvent when using solvent welding technology instead of UV. Specifically, this solvent welding technology is performed by simply applying an acetone solvent to a bonded area and drying the same, and through this process, adhesion of 16 kgf may be provided.

In an embodiment of the present disclosure, the press-fit ring and the lens barrel are fixed using solvent welding technology, and the solvent composition used at this time includes a first solvent and a second solvent, the first solvent includes at least one solvent selected from a first group having a swelling ratio of 60% or more, and the second solvent includes at least one solvent selected from a second group having a swelling ratio of less than 60%.

The solvent composition configured as described above may be applied to an area to which the press-fit ring and the lens barrel are bonded and dried at a temperature within a range of 60 to 90° C. for 20 minutes, thereby obtaining adhesion of 19 kgf.

Hereinafter, it is intended to confirm an excellent effect of the solvent composition of the present disclosure by comparing the solvent composition according to the present disclosure with a conventional case of bonding a solvent using AC.

### Test Example 1

To compare adhesion according to solvent characteristics, a swelling ratio and adhesion of flat specimens were measured for five types of solvents, AC, EA, MEK, THF, and MC, and are shown in FIG. 4.

Five types of solvents, AC, EA, MEK, THF, and MC, are prepared for the swelling ratio. Depending on the time, 1 ml of each solvent is dispensed into 1 g of polymer pellets and waited for 10, 30, and 60 minutes. Then, the weight of the pellets is measured, and an increase and decrease in the weight before/after waiting are compared so that the swelling ratio is calculated, as shown in Equation 1 below.

$$Swelling ratio = ( ( weight after waiting - initial weight ) / initial weight ) \times 100$$

The adhesion of the specimen is measured after producing a flat plate and a specimen with a diameter of 4 mm and applying and pressing five types of solvents, respectively. Specifically, 1 [symbol] of a solvent is applied between a contact surface of the specimen and a flat plate under a pressure of 0 to 0.1 kgf, respectively, heated and dried at 90° C. for 20 minutes, and then adhesion of each solvent is measured using a band tester.

Referring to FIG. 4, it can be seen that MC and THF, having high swelling characteristics, have high adhesion when a solvent is pre-applied to an adhesive surface and compressed.

On the other hand, it can be seen that MEK, EA, and AC have relatively low swelling characteristics and good spreadability on the surface as compared to other solvents. It can be seen that MEK, EA, and AC show excellent adhesion when divided, as if shooting a water gun into a gap between specimens after compression using jetting equipment. Therefore, a solvent composition obtained by mixing two types of solvents is expected to have better adhesion than a solvent composition containing only one type of solvent.

### Test Example 2

To evaluate a lens product, a solvent composition is prepared by mixing THF, which has an excellent swelling ratio, and MEK, which has excellent spreadability, and adhesion to a specimen is measured.

The solvent composition is screened for highly swellable THF at a ratio of 0, 30, 70, and 100% by volume. Then detailed evaluation is performed by changing the content of highly swellable THF to 10 to 50% by volume in the composition composed of THF and MEK.

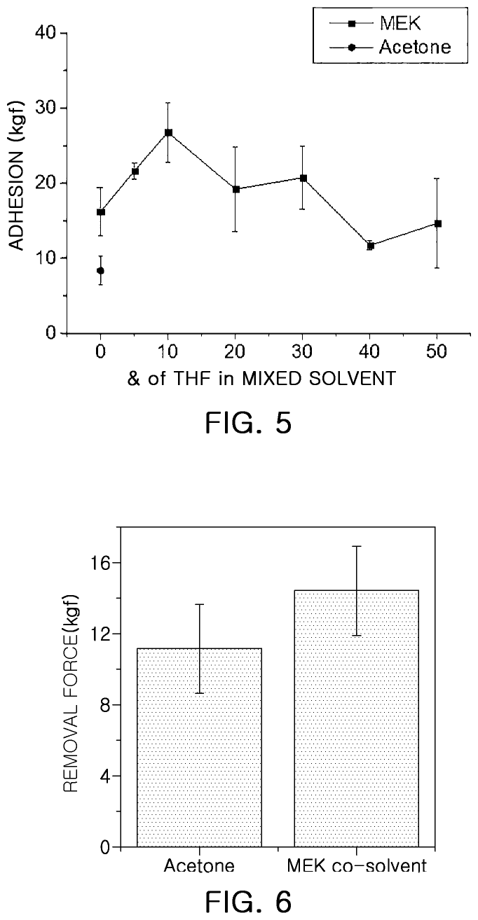

FIG. 5 is a graph illustrating a change in adhesion according to an amount of THF in the mixed solvent of THF and MEK. Referring to FIG. 5, it can be seen that the relatively lower the content of THF, the better the adhesion, and that the adhesion is relatively most excellent in a composition range containing 5 to 30% by volume of THF.

The removal force for a mixed solvent composition of MEK and THF is measured and compared after actual lens-barrel assembly using a solvent dispenser.

This removal force is obtained by producing a sample using an automatic dispenser, and a solvent is applied under conditions of a stroke of 54%, a line speed of 8 mm/s, and a pressure of 10 kpa. The applied sample is again pressed at 65° C. for 5 seconds at 0.1 kgf, pre-dried, and then secondarily dried at 90° C. for 20 minutes.

A press-fit ring of the sample model is designed to have a gap of −3 μm compared to a barrel. The removal force of the product is measured at a speed of 12 mm/min using a push-pull gauge.

FIG. 6 is a graph illustrating a comparison of removal force between adhesion using a conventional acetone solvent and adhesion using a mixed solvent of THF and MEK of the present disclosure.

Referring to FIG. 6, when using an AC single solvent in the prior art, the removal force is about 11 kgf, and when using a mixed solvent in the case of the present disclosure, the removal force is about 14 kgf. It can be seen that the removal force is excellent when the MEK-THF mixed solvent composition (mixing ratio MEK:THF=9:1) of an embodiment is used compared to the conventional bonding method using an AC single solvent.

### Test Example 3

After the adhesion of a lens product, whether a solvent applied through GC-MS analysis remains is evaluated.

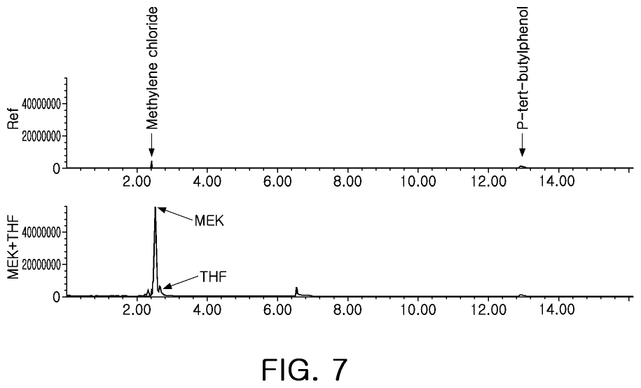

Referring to FIG. 7, as in an embodiment, after applying a mixed solvent composition of MEK and THF, even after drying at 90° C. for 20 minutes, the mixed solvent remains in a portion to which a mixed solvent applied or inside the lens barrel and is detected under heating conditions at 200° C.

Therefore, as described above, through Test Examples 1 to 3, it can be confirmed that when the press-fit ring and the lens barrel are bonded with a solvent composition in which a first solvent and a second solvent of an embodiment are mixed, excellent adhesion and removal force are obtained.

As set forth above, according to the present disclosure, a solvent composition for welding an optical module may be formed by mixing two types of solvents having different swelling ratios, and by the solvent composition for welding an optical module applied between a press-fit ring and a lens barrel, an effect of reducing a phenomenon of a lens being separated from the lens barrel due to an external impact may be improved.

When the lens is fixed by bonding the press-fit ring and the lens barrel with a solvent composition including first and second solvents of a mixed composition developed in the present disclosure as compared to a conventional acetone solvent, as a result of evaluating adhesion of a product, adhesion may be improved by about 30% as compared to the conventional acetone solvent.

Therefore, if the bonding force between the lens and the lens barrel increases, the drop reliability of an individual lens is improved, and the change in resolution in a subsequent thermal process is reduced so that an effect of reducing a defect rate during a manufacturing process of the camera module may be expected.

An aspect of the present disclosure is to provide a solvent composition for welding an optical module, which can prevent a lens from being separated from a lens barrel by improving the bonding force and removal force between the lens and lens barrel and a camera module using the same.

While specific examples have been shown and described above, it will be apparent after an understanding of this disclosure that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents. Therefore, the scope of the disclosure is defined not by the detailed description, but by the claims and their equivalents, and all variations within the scope of the claims and their equivalents are to be construed as being included in the disclosure.

What is claimed is:

1. A solvent composition for welding an optical module, comprising:
a first solvent comprising at least one solvent selected from a first group having a swelling ratio of 60% or more; and
a second solvent comprising at least one solvent selected from a second group having a swelling ratio of less than 60%.

2. The solvent composition of claim 1, wherein the first solvent is at least one of methylene chloride (MC) and tetrahydrofuran (THF), and
the second solvent is at least one of ethyl acetate (EA), methyl ethyl ketone (MEK), and acetone (AC).

3. The solvent composition of claim 2, wherein the first solvent is THF and the second solvent is MEK.

4. The solvent composition of claim 3, wherein the solvent composition comprises 70 to 95% by volume of MEK and 5 to 30% by volume of THF.

5. A camera module comprising:
a lens barrel accommodating a plurality of lenses; and
a press-fit ring disposed in the lens barrel to support the plurality of lenses,
wherein the solvent composition of claim 1 is used to couple the press-fit ring to the lens barrel.

6. A camera module comprising:
a plurality of lenses;
a lens barrel in which an accommodation space for accommodating the plurality of lenses is formed; and
a press-fit ring bonded to the lens barrel by a solvent composition comprising a first solvent selected from a first group having a swelling ratio of 60% or more, and a second solvent selected from a second group having a swelling ratio of less than 60%.

7. The camera module of claim 6, wherein the first solvent is at least one of methylene chloride (MC) and tetrahydrofuran (THF), and
the second solvent is at least one of ethyl acetate (EA), methyl ethyl ketone (MEK), and acetone (AC).

8. The camera module of claim 7, wherein the first solvent is THF and the second solvent is MEK.

9. The camera module of claim 8, wherein the solvent composition comprises 70 to 95% by volume of MEK and 5 to 30% by volume of THF.

10. The camera module of claim 6, wherein the plurality of lenses comprises a first lens group including a frontmost lens disposed most adjacently to an object, and a second lens group including a rearmost lens disposed most adjacently to an image plane, and
wherein the lens barrel comprises a first accommodation space for accommodating the first lens group and a second accommodation space for accommodating the second lens group.

11. The camera module of claim 10, further comprising:
a gap maintenance member disposed between the first lens group and the second lens group.

12. A solvent composition for welding an optical module, comprising:
a first solvent consisting of at least one solvent selected from a first group having a swelling ratio of 60% or more; and
a second solvent consisting of at least one solvent selected from a second group having a swelling ratio of less than 60%.

13. The solvent composition of claim 12, wherein the first solvent is at least one of methylene chloride (MC) and tetrahydrofuran (THF), and
the second solvent is at least one of ethyl acetate (EA), methyl ethyl ketone (MEK), and acetone (AC).

14. The solvent composition of claim 13, wherein the first solvent is THF and the second solvent is MEK.

15. A camera module comprising:
a lens barrel accommodating a plurality of lenses; and
a press-fit ring disposed in the lens barrel to support the plurality of lenses,
wherein the solvent composition of claim 12 is used to couple the press-fit ring to the lens barrel.
